(19) United States
(12) Patent Application Publication
(10) Pub. No.: US 2004/0092269 A1
(43) Pub. Date: May 13, 2004

(54) Determining location information in cellular network

(75) Inventor: Timo Kivinen, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/659,791

(22) Filed: Sep. 10, 2003

(30) Foreign Application Priority Data
Sep. 11, 2002 (FI) 20021629

(51) Int. Cl. H04Q 7/20; H04M 1/00; H04B 1/38

(52) U.S. Cl. 455/456.1; 455/433; 455/560; 455/466

(57) ABSTRACT

A method for determining cell-specific location information, wherein the cell-specific location information to be used in a mobile communication network is encrypted using a predetermined encryption algorithm. The geographical coverage area corresponding with a particular cell is determined and the cell-specific location information and the geographical coverage area information are stored in a database and interlinked. A cell positioning service request is transmitted from a mobile station to a service provider, the cell positioning service request including the encrypted, cell-specific location information on the mobile station and, in response to the request, the service provider retrieves from the database the geographical coverage area information corresponding with the encrypted, cell-specific location information on the mobile station in the request, and transmits a cell positioning service message to the mobile station, the cell positioning service message including at least the geographical coverage area information.

### FIELD OF THE INVENTION

The invention relates to cellular network based telecommunication systems, particularly to a procedure to be used in determining cell identities.

### BACKGROUND OF THE INVENTION

Typically, mobile communication systems are cellular systems, i.e. a coverage area of a mobile communication network is made up of cells, the coverage area of each cell being covered by one Base Transceiver Station (BTS) and the cells usually slightly overlapping with surrounding cells. Network operators control a mobile communication system by means of one or more Network Management Systems (NMS). Each cell in a cellular network should be identified individually in order for the network management system NMS to be able to control and monitor the mobile communication network in order to enable cell-specific services of the mobile communication systems to be provided and in order to enable mobile stations to check whether or not they have user rights to the services.

In a GSM system and in future 3G systems, for example, each cell is determined unambiguously by means of a Cell Global Identity (CGI) code. A CGI code is a standard combination made up of fourteen digits, which includes a Mobile Country Code (MCC), a Mobile Network Code (MNC), a Location Area Code (LAC) and a Cell Identity (CI). A CGI code is made up to hierarchically determine the country by the first four numbers (MCC), the mobile communication network by the next two numbers (MNC), the location area, i.e. the group of cells roughly determining the location, by the next four numbers (LAC), and the specific cell by the four last numbers (CI). As far as the operator is concerned, in the formation of a CGI cell the first two codes MCC and MNC are predetermined ones whereas the operator itself may decide the two last ones LAC and CI; typically, these two depend on the network structure. Consequently, a CGI code is often used as the cell location information in a system's internal data transmission between different elements of a GSM network.

Network operators and service providers operating therethrough develop different services for mobile communication systems that are based on the location information on a mobile station and wherein existing services of the mobile communication systems are developed into location information dependent services while brand-new services based on location information are being created. Services based on location information may be e.g. security services, such as emergency or accident information concerning a certain area, location-based billing service, such as lower billing rates within the area of the home or office cell of a mobile station, positioning services, such as updating location information on vehicles of a transport business via a mobile communication network, or common information services, such as information about happenings or traffic jams concerning a particular area.

The location of a mobile station can be determined by several different methods, each resulting in a different accuracy in the location information determination. A location can be determined e.g. at an accuracy of the cell of a mobile communication network to which the mobile station has connected at a given time, i.e. a Cell of Origin (COO), based on different triangulation methods (Enhanced Observed Time Difference E-OTD, Time of Arrival TOA), wherein the mobile station's signalling to different base transceiver stations is utilized, or by using satellite positioning, such as a Global Positioning System (GPS). A location update method used in connection with a service is typically dependent on the accuracy of the location information necessary for using the service.

Among the above-mentioned location update methods, the cell-based COO is the most useful for the consumer market at the moment since the other methods mentioned are either too expensive to use or they are unsophisticated in terms of technology. An obstacle to the cell-based positioning and the related services becoming more common is, however, the operator-dependency of the CGI codes. Due to business secrecy, network operators do not wish to give out information about the structure of their network to third parties, e.g. to a service provider providing services based on location information. The CGI codes include information on the architecture of the networks, and this information is not to be revealed to the third parties. Consequently, service providers operating as third parties are incapable of providing services based on cell positioning, which slows down the process of the cell location services becoming more common.

### BRIEF SUMMARY OF THE INVENTION

It has now been invented a method and an apparatus implementing the method to enable information necessary for cell positioning to be delivered also outside network operators without revealing the actual cell identities used in the network. Objects of the invention are achieved by a method, a system and a mobile station, which are characterized by what is disclosed in the independent claims.

Preferred embodiments of the invention are disclosed in the dependent claims.

The invention is based on encrypting the cell-specific location information on at least one cell in a cellular mobile communication network to be used in the particular mobile communication network by using a predetermined encryption algorithm, determining the geographical coverage area of at least the particular cell accurately enough, and storing the encrypted, cell-specific location information and the geographical coverage area information on at least the particular cell in a database such that the two aspects of the information are interlinked.

In accordance with a preferred embodiment, a data transfer connection can thus be established from a service provider external to the cellular mobile communication network to the database and utilize the encrypted, cell-specific location information and the geographical coverage area information on the particular cell in cell positioning services. The fact that, according to a preferred embodiment, the cell-specific location information on the mobile station to be used in the mobile communication network is encrypted in the mobile station connected to the cellular mobile communication network by using the predetermined encryption algorithm enables, according to a preferred embodiment, a positioning service to be implemented by transmitting a cell positioning service request from the mobile station to the service provider, the cell positioning service request including the encrypted cell-specific location information on the mobile station and, in response to the request, the service provider retrieving from the database through the data transfer connection the geographical coverage area information corresponding with the encrypted, cell-specific location information in the request, and transmitting a cell positioning service message to the mobile station, the cell positioning service message including at least the geographical coverage area information.

An advantage of the procedure is that network operators may deliver information necessary for cell positioning also to third parties without revealing the actual cell identities used in the network. A further advantage is that the third parties may collect the information from several network operators, in which case service provision covers most mobile users. A still further advantage is that communication methods already existing in mobile communication systems are applied, which means that different services based on location information are quick and easy to introduce.

### BRIEF DESCRIPTION OF THE DRAWINGS

The invention is now described in closer detail in connection with the preferred embodiments and with reference to the accompanying drawings, in which

FIG. 1 is a block diagram showing relevant parts of an arrangement of the invention on a network level;

FIG. 2 is a signalling diagram showing a cell positioning service in accordance with a preferred embodiment;

FIG. 3 is a signalling diagram showing a cell positioning service in accordance with a second preferred embodiment;

FIG. 4 is a signalling diagram showing a cell positioning service in accordance with a third preferred embodiment;

FIG. 5 is a signalling diagram showing a cell positioning service in accordance with a fourth preferred embodiment, and

FIG. 6 shows a structure of a mobile station in accordance with a preferred embodiment.

### DETAILED DESCRIPTION OF THE INVENTION

In the following, the invention will be described by way of example in connection with a GSM system, using partly GSM- or 3G-specific terminology. It is, however, obvious to one skilled in the art that the invention can be applied to any cellular network by using corresponding elements according to the invention. Furthermore, the figures to be explained in the following only show network elements relevant to the explanation of some embodiments of the invention, but it is obvious to one skilled in the art that cellular systems, such as the GSM system, also include several other network elements that need not be explained herein, however. As to the general structure of the GSM system, reference is made to the GSM specifications.

The invention is based on the idea that cell identities determined by operators, that is in the GSM system CGI codes, are encrypted by an encryption method to enable a cell identity to be encrypted and decrypted only in network elements maintained by an operator and in a mobile station connected to to the network of the particular operator. The method used for encrypting the cell identity is per se irrelevant to the implementation of the invention; any encryption method known per se may be used for the purpose. Encryption may be based e.g. on public key encryption of a similar type used in GSM subscriber authentication (A3 encryption) and in speech encryption (A5 encryption).

As far as a service provider operating as a third party is concerned, the point is that a database exists wherein these encrypted cell identities have been linked to the actual geographical location information on the cell, given at some accuracy. In methods based on cell positioning, location information can be determined under urban conditions typically at an accuracy of a few hundreds of metres, seldom at an accuracy of less than one hundred metres, whereas in sparsely populated areas the accuracy is decreased. The operator delivers these encrypted cell identities and the actual location information on a cell linked thereto either directly to the particular database or to the service provider to be further stored in the database. The actual location information can be determined e.g. as map coordinates and the range of variation therebetween, or e.g. as 100×100 m areas that are provided with predetermined identities. As to the accuracy of actual location information determination, the only point is that it substantially corresponds with the accuracy of cell positioning.

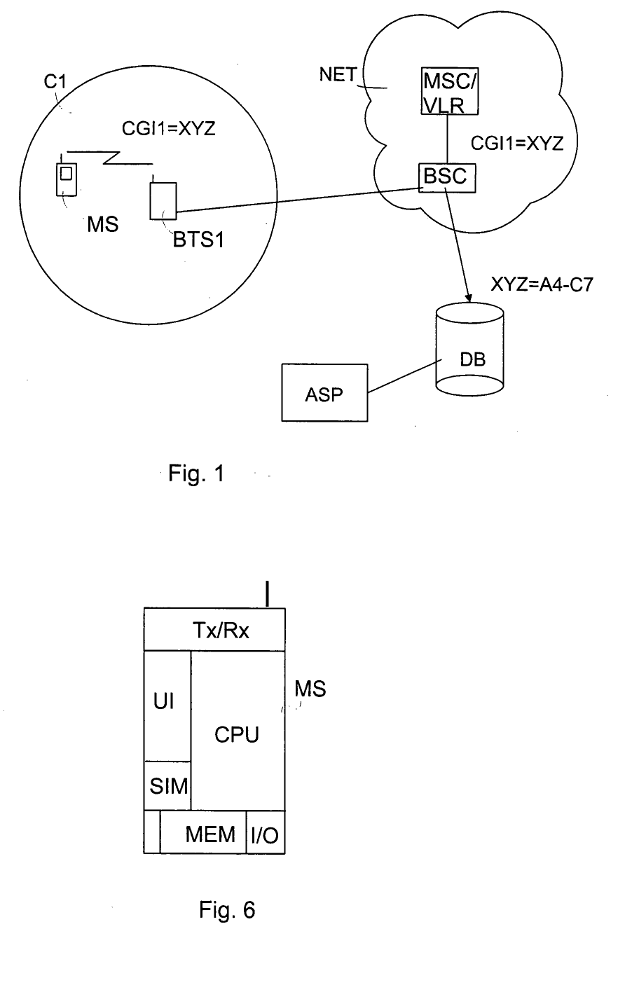

The basic idea of the invention can be illustrated by the arrangement of FIG. 1. In FIG. 1, a base transceiver station BTS1 generates a cell C1 to surround it, the cell C1 being provided with a cell identity CGI1, which may appear e.g. as a binary coded hexadecimal number 358f 40 1234 5678. A mobile station MS located within the area of the cell Cl is connected to the network via the base transceiver station BTS1, the mobile station MS thus knowing the cell identity CGI1 of the cell C1. The mobile station MS is configured to encrypt the cell identity CGI1 by a predetermined encryption algorithm, and as a result of the encryption, an encrypted cell identity XYZ is generated. The mobile station MS thus knows both the cell identity CGI1 to be used in the network and the encrypted cell identity XYZ.

The base transceiver station BTS1 is connected to the remaining mobile communication network NET, whose structure is known to one skilled in the art, so it is unnecessary to explain it in closer detail in connection with the present invention. Similarly, the network NET also knows the location of the mobile station MS in the cell C1, whose cell identity is CGI1. Also the network NET is configured to encrypt the cell identity CGI1 by using the same encryption algorithm, which results in an encrypted cell identity XYZ. In order to be able to utilize the encrypted cell identities e.g. in the applications of the third parties, the encrypted cell identities of the cells in the network and the actual location information thereon, such as map coordinates or other such information, are stored in a database DB. In FIG. 1, the cell identities are linked to predetermined map areas, e.g. to areas of 100×100 m that are provided with unambiguous identities. In FIG. 1, for example, the encrypted cell identifier XYZ corresponds with map areas A4 to C7. Preferably, a service provider ASP is provided with access to the database DB, which may be e.g. a database maintained by the service provider ASP.

The encrypted cell identities and the database DB containing the location information linked thereto enable cell positioning services to be implemented without the actual cell identities being delivered outside the operator network. Services may thus also be provided by a service provider operating as a third party; however, an operator may operate as a service provider as well. The network elements maintained by the operator and the mobile station connected to the network know the location of the particular mobile station at a given time at an accuracy of a cell, i.e. in the GSM system at an accuracy of a CGI code. According to the invention, both the mobile station and at least some network element, e.g. a visitor location register VLR in connection with a mobile services switching centre MSC, include means for encrypting cell identities on the basis of correct cell identities as well as means for decrypting such encryption. Preferably, the mobile station further includes means, typically an application to be used through a user interface, for generating different service requests wherein the encrypted cell identity of a particular cell of the mobile station is used.

Consequently, a mobile user desiring a service based on cell positioning generates a service request by employing such an above-mentioned application, the service request simply being e.g. a definition of the location of the mobile station. The service request, which includes the encrypted cell identity of the mobile station, is delivered to the service provider providing cell positioning e.g. as a Short Message Service (SMS) message or as an Extensive Markup Language (XML) message. The service provider checks the database for the actual location information corresponding with the particular encrypted cell identity. The actual cell identity is thus preferably not revealed to the service provider but the location of the mobile station can be determined on the basis of the encrypted cell identity. In response to the service request and the detection of the actual location information linked to the encrypted cell identity, the service provider delivers information to the mobile station on the actual location thereof at a similar accuracy to that used for the location information in the database. The location information to be delivered may be e.g. a map image to be conveyed onto the display of the mobile station to show the location area of the mobile station, in which case the location area can preferably be delivered using a so-called Multimedia Messaging Service (MMS) message. Naturally, any other appropriate message format, such as a Wireless Application Protocol (WAP) message, an XML message or a Smart Messaging™ message, can be used for delivering location information.

Preferably, the service provider operating as a third party may collect encrypted cell identities and the location information linked thereto preferably from several operators into a single database. The service provider is thus capable of providing services based on cell positioning for as many mobile users as possible. The encrypted cell identities of different operators may also be encrypted using different encryption methods, in which case mobile stations connected to the network of a particular operator include means necessary for encrypting and decrypting, either at least partly on a Subscriber Identity Module (SIM) card of the mobile station or as a separately loadable, operator-specific software application.

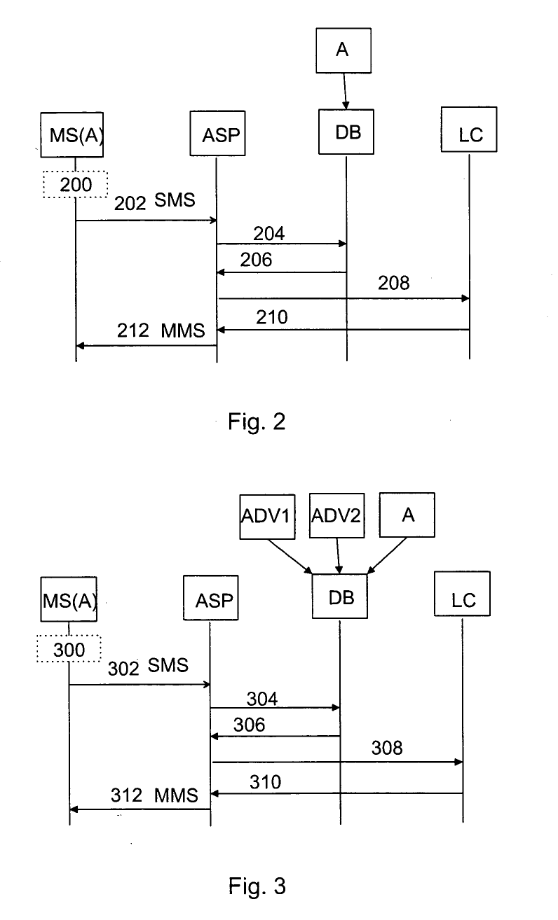

FIG. 2 shows a cell positioning service to be implemented according to a preferred embodiment of the invention. In this example, it is assumed that a user of a mobile station MS(A) connected to the network of operator A desires to receive a map of his or her current location area onto the display of his or her mobile station. First, the application in the mobile station MS(A) is used for encrypting (200) the current cell identity of the mobile station in network A. The encrypted cell identity and a service request (202) are transmitted to a service provider ASP. Preferably, the service request (202) can be transmitted as a short message service SMS. The service provider ASP has a connection to a database DB into which operator A has delivered encrypted cell identities and the location information linked thereto, either by directly storing them in the database DB or by delivering them to the service provider ASP to be further stored in the database DB. The service provider ASP enters a query (204) to the database DB, the query including the encrypted cell identity transmitted by the mobile station MS(A). In response to the query, the location information (206) corresponding with the encrypted cell identity is returned from the database DB.

The service provider enters a query (208) to a map database LC about a map image corresponding with the particular location information. A map image of the entire area wherein the cell positioning service is to be provided is stored in the map database LC preferably in graphic form, e.g. as a bit map format. In addition, different sectors of the map image are linked according to the actual location information provided by the database DB. In terms of implementation, the database DB and the map database LC can thus be easily implemented as a single database but in order to illustrate the implementation they have been separated in the present example. In response to the query, a graphic map image of at least the sector whose location information corresponds with the encrypted cell identity is thus returned from the map database LC (210). Preferably, the service provider ASP may add information to the map image e.g. on the current location of the mobile station at a known accuracy. Next, the service provider ASP inserts the map image into a message to be transmitted to the mobile station MS(A) and transmits the message e.g. as a multimedia messaging service MMS message (212), the reception of which by the mobile station MS(A) enables the map image to be displayed on the display of the mobile station MS(A).

The above-described embodiment may be modified in several different ways, which enables various services to be implemented. A mobile user may ask e.g. for a route map to a desired target destination. In such a case, a service request to be generated by the mobile station includes not only the current, encrypted cell identity of the mobile station but also a target destination identified in one way or another. The identification of the target destination may be provided e.g. as address information or as another unambiguous identity (National Theatre, Olympic Stadium, etc.). If the service provider does not recognize the target destination, it transmits an error message to the mobile station. If, again, the target destination is recognized, the service provider generates, in the above-described manner, a map image wherein the current location of the mobile station and the location of the target destination are indicated. The map image may further include a suggested route to the target destination e.g. for travelling by bicycle or car, the suggested route thus preferably taking into account bicycle paths and one-way streets, respectively.

Furthermore, the message containing a map image to be delivered to the mobile station may also include the encrypted cell identities of the cells located in the substantial vicinity of the current location of the mobile station as well as the location of the target destination, and the locations of the cells on the map. When moving within the area indicated by the map image, the mobile station thus monitors the actual cell identities delivered by the network, in the GSM system CGI codes, and compares them with the encrypted cell identities delivered in the message. When cells change, the encryption application in the mobile station determines the encrypted cell identity of the new cell and finds out the location of the particular cell on the map, in which case the map image is updated to show the changed location of the mobile station.

The above-described embodiment may also be implemented in a reverse direction. In such a case, the application in the mobile station is set to monitor mode, the mobile station then, while moving, monitoring the cell identities delivered by the network, in the GSM system CGI codes, and storing them in memory. When the monitoring stops, the cell identities stored in memory are encrypted according to the invention and transmitted to the service provider in the service request. The service provider generates, in the above-described manner, a map of the particular area as well as of the route (allegedly) travelled, the map then being transmitted to the mobile station. The map may further include other information, such as an estimate of the length of the distance travelled and the time used, which is preferably calculated using the monitoring start and end times delivered in the service request.

FIG. 3 shows a cell positioning service to be implemented according to a second preferred embodiment of the invention. In this example, it is assumed that a user of a mobile station MS(A) connected to the network of operator A desires to receive a map of his or her current location area onto the display of his or her mobile station, the map including the locations of the pizzerias in the vicinity. First, the application in the mobile station MS(A) is used for encrypting (300) the current cell identity of the mobile station in network A. The encrypted cell identity and a service request (302) are transmitted to a service provider ASP, which has a connection to a database DB provided with the encrypted cell identities and the location information linked thereto. The service further enables information presented by external advertisers ADV1, ADV2, such as location information on pizzerias, to be stored either directly in the database BD or in a map database LC. The service provider ASP enters a query (304) to the database DB, the query including the encrypted cell identity transmitted by the mobile station MS(A). In response to the query, the location information on the mobile station corresponding with the encrypted cell identity and possibly the location information on different pizzerias are returned from the database DB (306).

Next, the service provider enters a query (308) to the map database LC about a map image corresponding with the particular location information. In response to the query, a graphic map image of at least the sector whose location information substantially corresponds with the encrypted cell identity of the mobile station and the location of the pizzerias (310) is returned from the map database LC. Next, the service provider ASP adds information to the map image preferably on the current location of the mobile station at a known accuracy as well as the location information on the nearby pizzerias. Finally, the service provider ASP inserts the map image into a message to be transmitted to the mobile station MS(A) and transmits the message e.g. as a multimedia messaging service MMS message (312) to be displayed on the display of the mobile station MS(A). Illustrative, graphic information on the nearby, desired services is thus delivered to the mobile user quickly and in response to one service request.

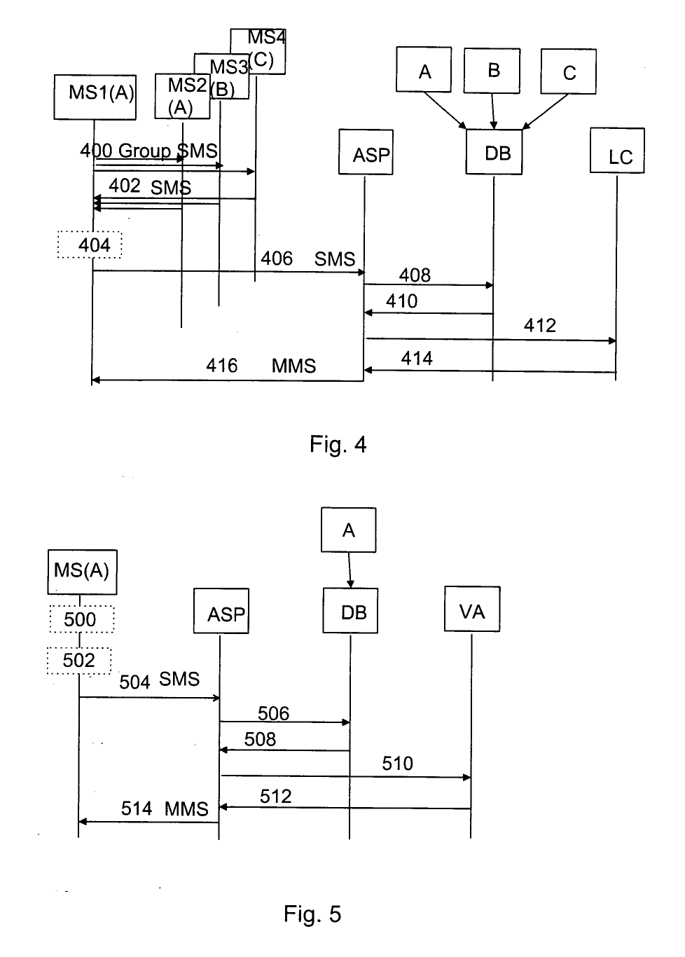

Furthermore, FIG. 4 shows a cell positioning service to be implemented according to a third preferred embodiment of the invention. In this example, it is assumed that a user of a mobile station MS1(A) connected to the network of operator A desires to receive a map onto the display of his or her mobile station to indicate the location of certain other, nearby mobile stations MS2(A), MS3(B) and MS4(C) in relation to the current location of the mobile station MS1(A). First, the mobile station MS1(A) queries the encrypted cell identity of the above other mobile stations e.g. by transmitting a so-called Group SMS message to the mobile stations (400). The mobile stations MS2(A), MS3(B) and MS4(C) reply to this by short messaging service messages (402), which include the encrypted cell identities of the mobile stations.

Assume that the mobile stations MS2(A), MS3(B) and MS4(C) operate in the networks of different operators A, B and C. In such a case, in order for the cell positioning service of the example to work, all operators A, B and C should deliver encrypted cell identities and the location information linked thereto to a database DB maintained by a service provider ASP. After the encrypted cell identities of the desired mobile stations have been received, the current cell identity of the mobile station in network A is encrypted using the application (404) in the mobile station MS1(A). All these encrypted cell identities and a service request (406) are transmitted to the service provider ASP e.g. as a short message service SMS. The service provider ASP enters a query (408) to the database DB, the query including the encrypted cell identities of the mobile stations MS1(A), MS2(A), MS3(B) and MS4(C). In response to the query, the location information (410) corresponding with the encrypted cell identities is returned from the database DB.

The service provider ASP enters a query (412) to a map database LC about a map image corresponding with the location information. In response to the query, a graphic map image of at least the section whose location information corresponds with the encrypted cell identities (414) is returned from the map database LC. The service provider ASP adds information to the map image preferably on the current location of all mobile stations at a determinable accuracy. Next, the service provider ASP inserts the map image into a message to be transmitted to the mobile station MS1(A) and transmits the message e.g. as a multimedia messaging service MMS message (416) to be displayed on the display of the mobile station MS1(A).

FIG. 5 shows a cell positioning service to be implemented according to a fourth embodiment of the invention, wherein it is shown by way of example how cell-specific value added services can be implemented in a preferred manner by using the procedure of the invention. In this example, it is assumed that the user of the mobile station MS(A) connected to the network of operator A has a contract for value added services with a service provider ASP, the value added services being in use in certain cells only. Such a service may be e.g. traffic jam information to be delivered in a city area exclusively. In order to start the service, the application in the mobile station MS(A) monitors the cell identities of a given cell of the mobile station in network A and compares them with the encrypted cell identities (500) which have been stored in memory and which determine the usage area of a value added service. When the application in the mobile station detects that the mobile station has moved into a cell wherein the particular value added service is in use, the service is activated.

The application in the mobile station MS(A) is then used for encrypting (502) the current cell identity of the mobile station in network A. The encrypted cell identity and a service activation request (504) are transmitted to the service provider ASP, which has a connection to a database DB provided with the encrypted cell identities and the location information linked thereto. The value added service subscriber contracts have also been stored in the database DB or in another database managed by the service provider ASP, user-specific usage areas of the service having been determined in this connection preferably by means of the encrypted cell identities. The service provider ASP enters a query (506) to the database DB, the query including the encrypted cell identity transmitted by the mobile station MS(A). The correctness of the encrypted cell identity and the subscriber's user right to the particular service are verified from the database DB. In response to the verification, an approving acknowledgement to the query and the location information (508) corresponding with the encrypted cell identity are returned from the database DB.

Next, the service provider enters a query (510) to a service management database VA to find out whether or not there exists a message relating to the particular service, such as information about a traffic jam in the vicinity of the location area of the mobile station, to be delivered to the current location area of the mobile station. In response to the query, a service message may be returned from the service management database VA, attached e.g. to a graphic map image of at least the section whose location information substantially corresponds with the encrypted cell identity of the mobile station (512). Next, the service provider ASP adds information to the map image preferably on the current location of the mobile station at a determinable accuracy. Naturally, a service message may also be generated text-based, without a graphic image. Finally, the service provider ASP inserts the service message into a message to be transmitted to the mobile station MS(A) and transmits the message e.g. as a multimedia messaging service MMS message or as a short message service SMS (514) to be displayed on the display of the mobile station MS(A).

The operators thus deliver the encrypted cell identities and the location information linked thereto to the service provider operating as a third party, and the service provider may then preferably collect this information from several operators into a single database. The operators may charge for delivering the information e.g. when network architectures change or at predetermined intervals. The information enabling services based on cell positioning to be provided for as many mobile users as possible is thus updated frequently enough for the service provider.

An important point in the above-described examples is the fact that the mobile station MS is configured to encrypt and decrypt cell identities. FIG. 6 illustrates the structure of a mobile station MS according to a preferred embodiment of the invention. The MS includes a transceiver Tx/Rx, which communicates with a base transceiver station BTS through an antenna. User Interface (UI) equipment typically includes a display, a keypad, a microphone and a loudspeaker. The MS further includes a Subscriber Identity Module (SIM) wherein e.g. short messages, operator-specific data or user-specific settings can be stored. A computer program code executed by a Central Processing Unit (CPU) may be stored in a memory MEM in the mobile station MS.

The functionality of the invention, wherein cell identities are encrypted and decrypted in the mobile station MS, is thus most preferably implemented as a program code stored in the memory MEM, configured to encode the cell identities, such as CGI codes, according to a predetermined algorithm and to deliver the encrypted cell identities further to the actual application program of the cell positioning service, which may be delivered e.g. by the service provider ASP. Similarly, the program code is configured to receive encrypted cell identities from the application program of the cell positioning service and to decode the encrypted identities according to a predetermined algorithm. It is to be noted that some of the source data used by the algorithm for encoding/decoding, such as encryption keys, may be operator-specific, in which case the source data portion can be stored on a SIM card. This enables the cell identities of different operators to be encrypted using at least partly different encryption methods. In order to confirm the reliability of the encryption, the algorithm is preferably executed as part of the software of the mobile station MS rather than in the application program of the cell positioning service. The actual application program, again, carries out the above-described functionalities, such as generation of service requests, location update for a map image and processing of cell identities stored in memory during monitor mode, on the basis of the encrypted cell identities. Most preferably, the above-described functionalities can be implemented by software, using existing processors and memories; however, it is also possible to use hardware solutions.

It is obvious to one skilled in the art that as technology advances, the basic idea of the invention can be implemented in many different ways. The invention and its embodiments are thus not restricted to the above-described examples but they may vary within the scope of the claims.

What is claimed is:

1. A method for determining cell-specific location information to be used in a mobile communication network, the method comprising
encrypting the cell-specific location information on at least one cell of the mobile communication network to be used in the particular mobile communication network by using a predetermined encryption algorithm,
determining substantially the geographical coverage area of the cell, and
storing the encrypted, cell-specific location information and the geographical coverage area information on the cell in a database such that the two aspects of the information are interlinked.

2. The method of claim 1, further comprising
establishing a data transfer connection from a service provider external to the mobile communication network to the database in order to use the encrypted, cell-specific location information and the geographical coverage area information on at least one cell in cell positioning services.

3. The method of claim 1, further comprising
encrypting, in a mobile station connected to the mobile communication network, the cell-specific location information on the mobile station to be used in the mobile communication network by using the predetermined encryption algorithm.

4. The method of claim 3, further comprising
transmitting a cell positioning service request from the mobile station to the service provider, the cell positioning service request including the encrypted, cell-specific location information on at least one mobile station,
in response to the request, retrieving from the database through the data transfer connection the geographical coverage area information corresponding with the encrypted, cell-specific location information on at least one mobile station in the request, and
transmitting a cell positioning service message to the mobile station, the cell positioning service message including at least the geographical coverage area information.

5. The method of claim 4, further comprising
transmitting the geographical coverage area information in the cell positioning service message as graphic map information, such as a bit map.

6. The method of claim 1, further comprising
storing the encrypted, cell-specific location information and the geographical coverage area information on the cells of several different mobile communication networks in the database such that the two aspects of the information are interlinked.

7. A system for determining cell-specific location information to be used in a mobile communication network, wherein
at least one network element of the mobile communication network is configured to encrypt the cell-specific location information on at least one cell to be used in the mobile communication network by using a predetermined encryption algorithm,
at least one network element of the mobile communication network is configured to determine substantially the geographical coverage area of the cell, and
the encrypted, cell-specific location information and the geographical coverage area information on the cell are configured to be stored in a database such that the two aspects of the information are interlinked.

8. The system of claim 7, wherein
a connection is provided from a service provider external to the mobile communication network to the database in order to use the encrypted, cell-specific location information and the geographical coverage area information on at least one cell in cell positioning services.

9. The system of claim 7, wherein
a mobile station connected to the mobile communication network is configured to encrypt the cell-specific location information on the mobile station to be used in the mobile communication network by using the predetermined encryption algorithm.

10. The system of claim 9, wherein
the mobile station is configured to transmit a cell positioning service request to the service provider, the cell positioning service request including the encrypted, cell-specific location information on at least one mobile station,
in response to the request, the service provider is configured to retrieve from the database the geographical coverage area information corresponding with the encrypted, cell-specific location information on at least one mobile station in the request, and to
transmit a cell positioning service message to the mobile station, the cell positioning service message including at least the geographical coverage area information.

11. The system of claim 10, wherein
the service provider is configured to transmit the geographical coverage area information in the cell positioning service message as graphic map information, such as a bit map.

12. The system of claim 10, wherein
the cell positioning service message further includes at least some of the following information:
location information on at least one other mobile station
location information on at least one service determined in the service request
suggested route to a target destination determined in the service request
estimated length of distance to be travelled and time used by the mobile station on alleged route
information on a cell-specific service.

13. The system of claim 7, wherein
the encrypted, cell-specific location information and the geographical coverage area information on the cells of several different mobile communication networks are configured to be stored in the database such that the two aspects of the information are interlinked.

14. A mobile station, which is configured to
establish a connection to a mobile communication network, and
encrypt the cell-specific location information on the mobile station to be used in the mobile communication network by using a predetermined encryption algorithm.

15. The mobile station of claim 14, which is further configured to
transmit a cell positioning service request to a service provider providing a cell positioning service, the cell positioning service request including the encrypted, cell-specific location information on at least one mobile station, and
receive a cell positioning service message from the service provider, the cell positioning service message including at least the geographical coverage area information corresponding with the encrypted, cell-specific location information.

16. The mobile station of claim 15, which is further configured to present the geographical coverage area information in the cell positioning service message as graphic map information, such as a bit map.

17. The mobile station of claim 15, which is further configured to
receive from the service provider the cell positioning service message including at least one aspect of the encrypted, cell-specific location information and the geographical coverage area information linked thereto,
determine the encrypted, cell-specific location information corresponding with its location, and
update its current location into the geographical coverage area information in the cell positioning service message.

18. The mobile station of claim 15, which is further configured to
determine the encrypted, cell-specific location information corresponding with its location,
in response to a change in location, store successive encrypted, cell-specific location information,
transmit a cell positioning service request to a service provider providing a cell positioning service, the cell positioning service request including the encrypted, cell-specific location information stored in memory, and
receive a cell positioning service message from the service provider, the cell positioning service message including at least the geographical coverage area information corresponding with the encrypted, cell-specific location information stored in memory.

19. The mobile station of claim 15, including
computer program means for encoding cell-specific location information on mobile stations to be used in a mobile communication network into encrypted cell identities according to a predetermined algorithm, and
computer program means for decoding the encrypted cell identities into cell-specific location information on a mobile station to be used in the mobile communication network according to a predetermined algorithm.

20. The mobile station of claim 19, including
computer program means for generating a cell positioning service request to a service provider providing a cell positioning service, the cell positioning service request including the encrypted cell identity of at least one mobile station.
